(19) United States
(12) Patent Application Publication
(10) Pub. No.: US 2024/0058774 A1
(43) Pub. Date: Feb. 22, 2024

(54) Mixing Device

(71) Applicant: Peeters Landbouwmachines B.V., ETTEN-LEUR (NL)

(72) Inventor: Daniel Petrus Marie PEETERS, ETTEN-LEUR (NL)

(21) Appl. No.: 18/260,863

(22) PCT Filed: Jan. 19, 2022
(86) PCT No.: PCT/NL2022/050023

§ 371 Date: Jul. 10, 2023

(30) Foreign Application Priority Data
Jan. 19, 2021 (NL) 2027346

(51) Int. Cl. B01F 27/052; B01F 27/172; B01F 27/808; B01F 27/9212; B01F 27/922

(52) U.S. Cl. CPC B01F 27/052; B01F 27/172; B01F 27/808; B01F 27/9212; B01F 27/922

(57) ABSTRACT

A mixing device includes a holder and a mixing element. The mixing device has a central axle and rotates in relation to the holder about an axis of rotation which coincides with the central axle. The mixing element includes an axle body and a plate-shaped mixing body. The mixing element further includes a plate-shaped wearing body, and connecting elements. The shanks of the connecting elements respectively extend through or at least into associated mutually aligned first holes in the wearing body and second holes in the mixing body. The mixing body is provided with recesses in the middle of which the associated second holes are provided, wherein parts of the wearing body that surround the first holes extend within the recesses.

The present invention relates to a mixing device comprising a holder for holding material to be mixed in a mixing chamber of the holder, a mixing element which is provided in the mixing chamber, has a central axle and is rotatable in relation to the holder about an axis of rotation which coincides with the central axle for the purpose of mixing the material to be mixed in the mixing chamber during rotation of the mixing element, the mixing element comprising an axle body and a plate-shaped mixing body of at least partially screw-shaped form which extends around the axle body, is connected to the axle body and has a peripheral edge on the side facing away from the axle body, and also a plate-shaped wearing body, connecting elements each having a head and a shank, one end of said shank adjoining the head, wherein the shanks of the connecting elements respectively extend through or at least into associated mutually aligned first holes in the wearing body and second holes in the mixing body, and by means of which connecting elements the at least one wearing body is releasably connected to the mixing body, wherein the at least one wearing body at least partially extends on the outer side of the peripheral edge. In particular, the invention relates to a mixing device for mixing livestock feed, which may comprise, for example, maize and grass.

American publication U.S. Pat. No. 6,328,465 B1 describes such a mixing device for livestock feed. The mixing device in question comprises a mixing element embodied as an auger, the mixing body of which embodied as an auger flight has a substantially spiral-shaped or screw-shaped form. The auger flight has an outer periphery having straight parts and corners which connect the straight parts to one another. The mixing element further comprises wearing bodies embodied as cutting blades which are spaced apart from each other on the auger flight and are connected to the auger flight by means of rivets. In this case, the cutting blades partially extend on the outer side of the outer periphery of the auger flight.

German publication DE 20 2004 013 031 U1 also describes a mixing device for livestock feed having a screw-shaped mixing element. At the periphery of the mixing element, the mixing device is provided with wearing elements embodied as cutting blades which are spaced apart from each other on the underside of the mixing element and are connected to the mixing element by means of bolts, the associated shanks of which extend through mutually aligned holes in the cutting blades and in the mixing element. The heads of the bolts are recessed into recesses in the upper surface of the mixing element.

Due to the mechanical load acting on the cutting blades during operation and due to wear of the wearing elements and/or riveters or bolts which are used to connect the wearing elements to the mixing element, there is the risk of the bolts and/or riveters breaking, thus resulting in the possibility of the wearing elements unintentionally coming loose from the mixing body, which may lead to damage and dangerous situations. It is the object of the invention to mitigate the aforementioned risk. To this end, the mixing body, at the location of the second holes therein, on the side facing toward the wearing body, is provided with recesses in the middle of which the associated second holes are provided, wherein parts of the wearing body that surround the first holes extend within the recesses. It is thus possible for these parts to bear against the wall of the recesses, as a result of which the connecting elements are subjected to shearing at least to a reduced extent, if at all, during operation. Indeed, the fact that the connecting elements are subjected to shearing entails an increased risk of the connecting elements breaking. An additional advantage is that the connecting elements can also have a more lightweight design. In addition, the wearing body can be positioned correctly in relation to the mixing body in a relatively simple manner.

The last-mentioned advantage is relevant, in particular, but not exclusively, if each recess has an inclined flank, as a result of which a self-locating effect can be achieved. An inclined flank also entails the advantage, in particular if the head of each connecting element has a conical form, in which case the vertex of the conical form fits with the inclination of the flank, that an external force which is exerted on the wearing body and which would lead to a shear load on the connecting elements in the case of the prior-art mixing devices is at least partially converted into a tensile load on the connecting elements.

According to a possible embodiment, each recess is produced by machining of the mixing body, as a result of which both the position and the dimensions of the recesses can be configured accurately.

In an embodiment that may be favorable both in terms of construction and costs, the wearing body is produced from a plate and the parts of the wearing body that surround the first holes and that extend within the recesses are formed by plastic deformation, preferably by bending, of the plate. It is thus also possible for the thickness of the wearing body to be limited to, for example, a maximum of 12 mm or even a maximum of 10 mm. In addition, when using sheet steel, bending has the additional advantage of strengthening on account of the bending, as a result of which the wearing body can become more wear-resistant.

In a further embodiment, a raised edge is provided at the periphery of each of the first holes in the wearing body on the side facing away from the mixing body. In this case, the raised edges thus do not have to be directly adjacent to the first holes. The raised edges therefore protect the heads of the connecting elements, as a result of which the connecting elements will wear less rapidly and replacement of the wearing bodies and/or connecting elements will be required less frequently.

An increased level of protection of the heads of the connecting elements is relevant, in particular, if the head of each connecting element extends completely under the highest level of the raised edge around the associated first hole in the wearing body. In addition, the heads then also do not form an obstacle for the feed to be mixed, so that the feed can slide from the mixing body and from the wearing bodies more easily.

If each raised edge has an inclined flank on the side facing toward the first hole, it is advantageously possible to use connecting elements having a conical head, in which case the conical form of the head fits with the inclined flank of the first hole.

A very efficient way of producing the raised edge may be achieved if each raised edge is produced by plastic deformation of the wearing body, or even, in particular, if the raised edge also has an inclined flank as described above. Alternatively, the raised edge could also be implemented by way of a ring whose hole is aligned with a first hole and which is welded to the mixing body.

In the case of plastic deformation, it may be preferable for the wearing body to be produced from a plate and for the raised edge to be formed by bending of the plate. The bending may then lead to a strengthening of the material of the wearing body, and thus increased wear resistance, while it is additionally possible for the wearing body to be of relatively thin design as has also already been mentioned above.

A further increased protection of the heads of the connecting elements may be achieved if the wearing body is produced from a plate and each first hole in the wearing body at least partially extends on the side of the thickness of the plate facing away from the associated raised edge.

A highly practical embodiment may be achieved if the connecting elements are embodied as bolts and wherein a nut for each bolt is provided on the side of the mixing body facing away from the wearing body, wherein the nut is screwed onto the bolt and the mixing body and the wearing body are clamped against each other by the bolt head of the bolt and by the nut.

The invention may advantageously be used, in particular, but not exclusively, if cutting teeth form at least a part of the peripheral edge of the wearing body. With the aid of the cutting teeth, the mixing device can reduce the size of the material to be mixed to an increased extent, as is of importance in particular in the case of livestock feed.

Surprisingly, it has been found that, at least when mixing livestock feed, the mixing process can be improved if at least a part of the periphery of the wearing body has a corrugated form. Such a corrugated form, which is, moreover, free of cutting edges and has a smooth profile, can exert a massaging action on the livestock feed during operation without reducing the size of the livestock feed.

Furthermore, it may be advantageous for at least a part of the peripheral edge of the wearing body to be beveled in cross section. With the aid of such a bevel, it is for example possible to establish a good connection to a stepped form of the plate-shaped mixing body, as will be discussed below as a possible embodiment. Furthermore, such a bevel may also be advantageous for guiding material to be mixed by the mixing device.

In a further embodiment, the mixing device is provided with a number of wearing bodies which are releasably connected to the mixing body and which adjoin each other, wherein the number of wearing bodies may collectively be provided along at least 90% of the length of the outer peripheral edge of the mixing body, preferably along the full length of the outer peripheral edge of the mixing body. With such percentages, the wearing bodies contribute greatly to the service life of the mixing element. Such an advantage may also be relevant if the mixing body of the mixing device is not provided with recesses into which parts of the at least one wearing body extend. The result is thus a mixing device comprising a holder for holding material to be mixed in a mixing chamber of the holder, a mixing element which is provided in the mixing chamber, has a central axle and is rotatable in relation to the holder about an axis of rotation which coincides with the central axle for the purpose of mixing the material to be mixed in the mixing chamber during rotation of the mixing element, the mixing element comprising an axle body and a plate-shaped mixing body of at least partially screw-shaped form which extends around the axle body, is connected to the axle body and has a peripheral edge on the side facing away from the axle body, and also a number of plate-shaped wearing bodies, connecting elements each having a head and a shank, one end of said shank adjoining the head, wherein the shanks of the connecting elements respectively extend through or at least into associated mutually aligned first holes in the wearing bodies and second holes in the mixing body, and by means of which connecting elements the wearing bodies are releasably connected to the mixing body, wherein each of the wearing bodies at least partially extends on the outer side of the peripheral edge, and wherein the number of wearing bodies are collectively provided along at least 90% of the length of the peripheral edge of the mixing body.

In a further embodiment, the number of wearing bodies comprises at least one wearing body on at least a part of the periphery of which cutting teeth are provided, and comprises at least one wearing body on the periphery of which no cutting teeth are provided and at least a part of which periphery preferably has a corrugated form.

If the plate-shaped mixing body has a stepped form in cross section, having a first step part and a second step part, which is connected to the first step part, on the radial outer side of the first step part, wherein the first step part and the second step part are situated at a step distance from each other in cross section and in a direction parallel to the central axle, wherein the wearing body bears against the second step part, it is possible to obtain the advantage that the plate-shaped mixing body has a greater stiffness compared with the situation where such step parts are not provided. As a result, to achieve a similar stiffness, the thickness of the plate-shaped mixing body can be selected to be smaller. Furthermore, it is possible to obtain the advantage that the wearing body is, as it were, recessed and is therefore less susceptible to wear. Within the context of this specific embodiment of the present invention, it is moreover not necessary for the plate-shaped mixing body to have a stepped cross section over the full length of its peripheral edge, which cross section thus extends transverse to the peripheral edge.

The aforementioned advantages are also relevant for prior-art mixing devices. This then results in a mixing device comprising a holder for holding material to be mixed in a mixing chamber of the holder, a mixing element which is provided in the mixing chamber, has a central axle and is rotatable in relation to the holder about an axis of rotation which coincides with the central axle for the purpose of mixing the material to be mixed in the mixing chamber during rotation of the mixing element, the mixing element comprising an axle body and a plate-shaped mixing body which extends around the axle body, is connected to the axle body and has a peripheral edge, and also a plate-shaped wearing body, connecting elements each having a head and a shank, one end of said shank adjoining the head, wherein the shanks of the connecting elements respectively extend through or at least into associated mutually aligned first holes in the wearing body and second holes in the mixing body, and by means of which connecting elements the at least one wearing body is releasably connected to the mixing body, wherein the at least one wearing body at least partially extends on the outer side of the peripheral edge, wherein the plate-shaped mixing body has a stepped form in cross section, having a first step part and a second step part, which is connected to the first step part, on the radial outer side of the first step part, wherein the first step part and the second step part are situated at a step distance from each other in cross section and in a direction parallel to the central axle, wherein the wearing body bears against the second step part.

The aforementioned advantage of the recessed positioning of the wearing body may be relevant, in particular, if the size of the step distance is between 50% and 150% of the thickness of the wearing body, preferably between 90% and 110% of the thickness of the wearing body.

In a practical embodiment, the mixing body has an at least partially screw-shaped form, and/or the axis of rotation is oriented vertically, and/or the mixing device is provided with a movable chassis having the holder thereon. For the sake of completeness, it is noted that where terms such as above, below, horizontally or vertically are used in the foregoing or in the text which follows, this must be viewed in terms of the implemented form of the mixing device.

If the at least one wearing body is provided on the top side of the mixing body, this may lead to reduced wear of the mixing body and, in addition, may make the replacement of the wearing bodies easier.

In addition to a mixing device, the present invention also relates to a mixing element as such, and to a plate-shaped wearing body as such, for use in a mixing device according to the invention, possibly in potential embodiments thereof as discussed above including the accompanying advantageous aspects that may apply to such embodiments.

The invention also relates to a method for producing a wearing body for use in a mixing device according to the invention. The method comprises the steps of
providing a plate-shaped base body,
plastically deforming, preferably bending, the plate-shaped base body such that a recessed part is formed,
making a through-hole in the recessed part.

In a further embodiment, a circular raised edge that surrounds the recessed part is also formed during the plastic deformation, preferably bending, of the plate-shaped base body.

It is thus possible to produce a wearing body in an efficient manner. In this case, the plastic deformation may be suitably carried out with the aid of a press. Although it is possible within the context of the invention for the through-hole to be made before the recessed part, and possibly the circular raised edge, is formed by means of plastic deformation, in which case it is thus necessary to anticipate the final position of the recessed part, and possibly of the circular raised edge, when making the through-hole, it is preferable for the through-hole to be made only after the recessed part, and possibly the circular raised edge, has been formed because then the formation of the recessed part or of the circular raised edge has no influence on the form of the through-hole.

In order to make the wearing bodies suitable for effectively reducing the size of material to be mixed, such as livestock feed, in a further embodiment, the method also comprises the step of forming cutting teeth at the periphery of the plate-shaped base body.

The invention will be explained in more detail by way of the description of possible embodiments of the invention on the basis of the following figures:

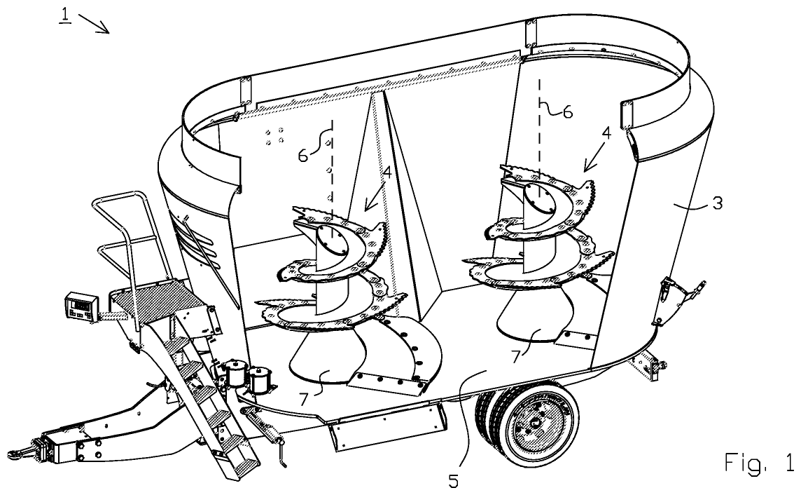

FIG. 1 shows a perspective view of a mixing device according to the invention;

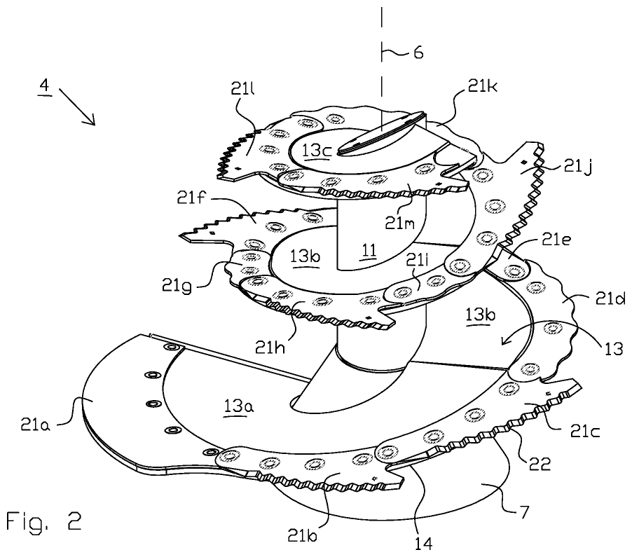

FIG. 2 shows a perspective view of a mixing element as used in the mixing device according to FIG. 1;

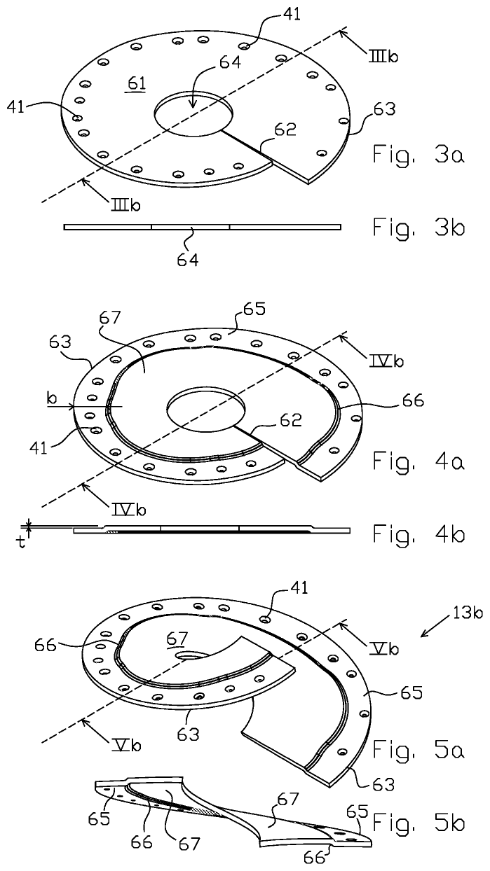

FIGS. 3a, 4a and 5a show perspective views of consecutive phases of the process for producing a mixing body which forms part of a mixing element according to FIG. 2;

FIGS. 3b, 4b and 5b show cross sections along lines IIIb-IIIb, IVb-IVb and Vb-Vb in the respective FIGS. 3a, 4a and 5a;

FIGS. 6, 7a, 8a and 9a show perspective views of consecutive phases of the process for producing a wearing body which forms part of a mixing element according to FIG. 2;

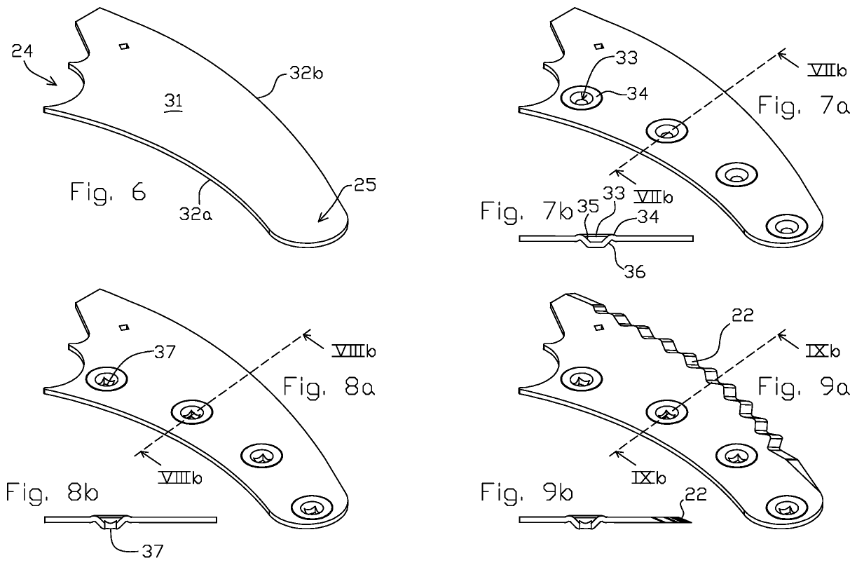

FIGS. 7b, 8b and 9b show cross sections along lines VIIb-VIIb, VIIIb-VIIIb and IXb-IXb in the respective FIGS. 7a, 8a and 9a;

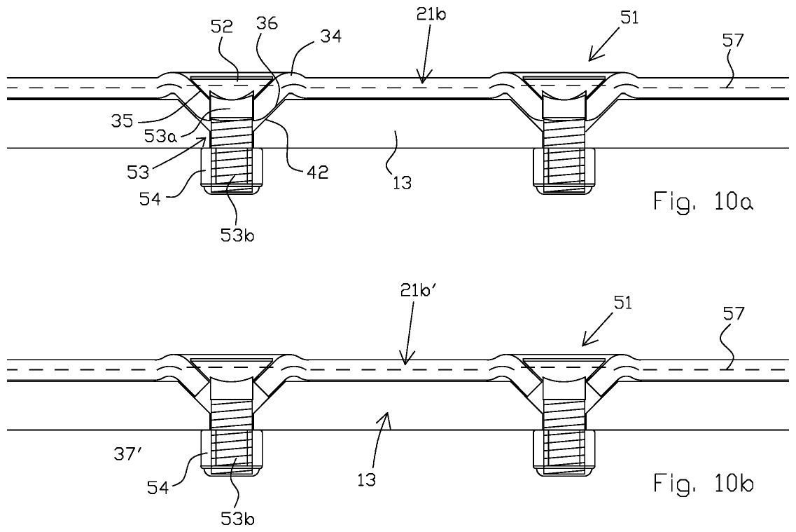

FIGS. 10a and 10b show cross sections of details of a mixing element according to two respective embodiments;

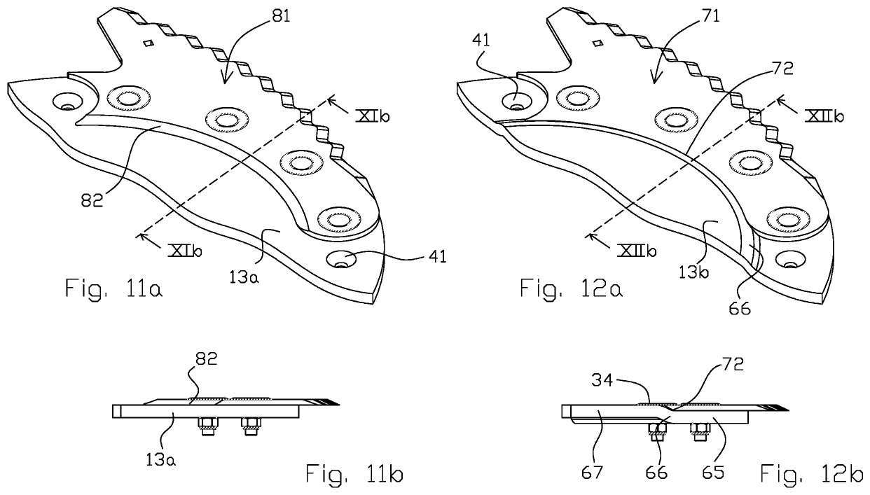

FIG. 11a shows a perspective view of another embodiment of a wearing element;

FIG. 11b shows the cross section along line XIb-XIb in FIG. 11a;

FIG. 12a shows a perspective view of yet another embodiment of a wearing element;

FIG. 12b shows the cross section along line XIIb-XIIb in FIG. 12a.

FIG. 1 shows a mixing device according to the invention embodied as a towed feed-mixing wagon 1. Feed-mixing wagons are known per se to those skilled in the art and are used for the mixing and cutting of feed and the metered delivery of feed to livestock. The feed-mixing wagon 1 comprises a movable chassis 2 having a tank 3 thereon. Two mixing elements which are embodied as augers 4 and which extend perpendicular to the bottom 5 of the tank 3 and which are each rotatable about respective axes of rotation 6 by means of drive means (not shown in any more detail) are provided in the tank 3. Axes of rotation 6 are oriented vertically or at least perpendicular to the bottom 5.

FIG. 2 shows an auger 4 in more detail, including a cylindrical axle body 11 and a conical guide element 7 which is fixedly welded thereto. The central axis of the cylindrical axle body 11 coincides with that of the (associated) axis of rotation 6. At the bottom end, axle body 11 extends through a central opening in the guide element 7. At the top end 12, the axle body is beveled. Auger 4 further comprises a plate-shaped mixing body 13 embodied as a so-called auger ribbon 13. Auger ribbon 13 has a screw-shaped or spiral-shaped form and consists of three auger ribbon parts 13a, 13b and 13c that are welded to each another. The inner sides of auger ribbon parts 13b and 13c are welded to the outer side of the axle body 11. Auger ribbon part 13a extends around guide element 7 and is fixedly welded thereto.

On the side facing away from the axle body 11, auger ribbon 13 has a spiral-shaped peripheral edge 14 which is largely hidden in FIG. 2. The spiral form has a larger diameter at the bottom end than at the top end. More specifically, the diameter d13a of the spiral form of the bottom auger ribbon part runs, starting from the underside, from 190 cm to 120 cm at half the length of auger ribbon part, i.e. after a quarter turn. Above this, the diameter d13a is constant. The diameter d13b of the spiral form of the middle auger ribbon part 13b is also not constant over its length. Specifically, the size of d13b gradually declines from 120 cm at the bottom end of auger ribbon part 13b to 85 cm at the top end of auger ribbon part 13b. The diameter d13c of the spiral form of the top auger ribbon part 13c, however, is constant over its full length and has a size of 85 cm. It generally holds true that the auger ribbon 13 essentially has a tapered form in side view. The auger ribbon parts 13a, 13b and 13c respectively extend over a curve angle of 180 degrees, 360 degrees and 345 degrees. It is emphasized that the values stated in this paragraph serve only as an illustrative example. In particular, but not exclusively, the diameter values may be both larger and smaller than the stated values, for example up to 30% smaller and up to 30% larger. Auger ribbon parts 13a, 13b and 13c also differ from each another in that auger ribbon parts 13b and 13c, in contrast to auger ribbon part 13a, have a stepped form in cross section, as will be explained below on the basis of FIGS. 3a to 5b, 12a and 12b.

Auger 4 further comprises a number of adjoining wearing bodies 21a to 21m which, as seen in plan view or at least in a view parallel to axis of rotation 6, largely cover the peripheral edge 14 and, to this end, are provided on the top side of the auger ribbon 13 and are releasably connected thereto in a manner that is to be described further below. Since it is specifically the top side and the outer side of the auger ribbon 13 that are most prone to wear, it is advantageous that the wearing bodies are provided on the top side of the auger ribbon 13. This does not preclude the fact that the wearing bodies may also be provided on the underside of the auger ribbon 13 in an alternative embodiment of the invention.

The wearing bodies 21b, 21c, 21e, 21f, 21h, 21j, 21l and 21m are embodied as cutting bodies and have on their outer sides cutting teeth 22 with cutting edges for the purpose of cutting feed in the tank 3 of the feed-mixing wagon 1, as is known per se to those skilled in the art. The other wearing bodies 21a, 21d, 21g, 21i and 21k are not embodied as cutting bodies but also protect the peripheral edge 14 of the auger ribbon 13 against wear. Said other wearing bodies, with the exception of the bottom wearing body 21a, have a smooth wavy pattern 23 on the outer part of their periphery, where no cutting edges are provided. In this way, these wearing bodies also exert a massaging action on the feed in the tank 3 of the feed-mixing wagon 1. Due to this massaging action, the feed to be mixed/cut moves more. Wearing body 21a is relatively large because the tendency to wear is greatest in the bottom part of the tank 3.

Insofar as the difference between the various wearing bodies 21a to 21m is not of importance, the reference numeral 21 will be used below for all wearing bodies 21a to 21m, regardless of the embodiment thereof. At the mutually facing ends, the periphery of the wearing bodies 21 is either concave (24 in FIG. 6) or convex (25 in FIG. 6), the concave and convex forms being complementary and therefore fitting into each other so that a good mutual connection of the wearing bodies 21 is obtained. The wearing bodies 21 thus collectively form, as it were, a spiral-shaped ribbon which virtually completely protects the peripheral edge 14 of the auger ribbon 13. The only exception is the top end of the peripheral edge 14, as is visible in FIG. 2.

FIGS. 6 to 9b relate to consecutive steps during the production of a cutting body 21b (or identical cutting body 21c). FIG. 6 shows a plate-shaped base body 31 which has been cut from sheet steel having a thickness of between 5 mm and 10 mm, for example of 8 mm. In plan view, the base body 31 has a slightly curved elongate form having a curved concave inner edge 32a and a curved convex outer edge 32b and having a cavity 24 at one end 24 and a convex end 25 situated opposite. Starting from the convex end 25, the outer edges 32a and 32b deviate from each other slightly, with the result that the base body also has a slightly tapered form.

In FIGS. 7a and 7b, it is possible to see how four round recesses 33 having a raised circular edge 34 surrounding them are formed by means of plastic deformation, more specifically bending, of the plate-shaped base body 31 in a press. In the regions where bending has been performed, said bending has a strengthening effect on the material of the base body 31, as a result of which the latter becomes more wear-resistant. There are respectively inclined flanks 35 on the inner side of the raised edges 34, while there are also circular inclined flanks 36 on the outer side of the recess 33 and on that side of the base body which is situated opposite the raised edges 34. As is visible in FIG. 7b, the top side of the lowest part of recess 33 is in line with the underside of the base body 31 insofar as it extends on the outer side of the raised edge 34, or is even slightly under it. When the feed-mixing wagon 1 is being used, the aforementioned underside bears against the top side of the auger ribbon 13.

In FIGS. 8a and 8b, it is possible to see how square through-holes 37 are then introduced at the location of these round recesses 34 by means of punching operations. In FIGS. 9a and 9b, it is possible to see how the aforementioned cutting teeth 22 are then formed at the location of the curved outer edge 32b by means of machining.

In FIG. 10a, it is possible to see how the cutting body 21b is releasably connected to auger ribbon 13. In the auger ribbon 13, through-holes such as the through-holes 41 shown in FIGS. 3a, 4a, 5a, 11a and 12a are provided at positions corresponding to those of holes 37 so that holes 37 can be aligned with respect to holes 41. The side of those holes 41 which faces toward the cutting body 21b has a tapered form with a circular inclined flank 42. The cutting body 21b is positioned against the top side of the auger ribbon 13 in such a way that holes 37 in the cutting body 21b are aligned with associated holes 41 in the auger ribbon. In this case, the inclined flanks 36 and 42 bear against each other, as a result of which the height of the hole 37 extends completely or virtually completely within the thickness of the auger ribbon 13.

In order to connect the cutting body 21b and the auger ribbon 13 to each other in a releasable manner, use is made of recessed bolts 51, preferably made of hard metal, which each have a conical head 52 and a shank 53 adjoining the head 52, and of nuts 54. The end of the shank 53 directed toward the head 52, at the location of reference numeral 53a, has a square cross section which fits precisely into hole 37 and can be received therein in a form-fitting manner. The rest of the shank 53 is provided with a screw thread 53b. The shank 53 of the bolt 51 is inserted through the mutually aligned holes 37 and 41, with the conical head 52 bearing against the inclined flank 35. The nut 54 is screwed onto the screw thread 53b, and, by suitable tightening of nut 54, cutting body 21b is pulled against the auger ribbon 13 in a clamping manner. The head 52 of the bolt 51 extends completely under the top side of the raised edge 34. This protects head 52 against wear which occurs due to friction with the feed in the tank 3 when an auger 4 is rotating about the associated axis of rotation 6. FIGS. 10a and 10b also show, by way of dashed line 57, the thickness to which the cutting body 21b/21b′ can be abraded from the top side before replacement is required. Said thickness is then approximately halved. Bolt 51 is then still able, in spite of the wear of the head 52 thereof, to provide a sufficiently secure connection between the cutting body 21b/21b′ and the auger ribbon 13. This means that any external force on the wearing body 21 that is directed perpendicular to the length direction of the shanks 53 of bolts 51 results in the bolt 51 being loaded primarily in a direction perpendicular to the aforementioned external force, namely in tension, due to the abutment of inclined flanks 36 against inclined flanks 42.

It is also conceivable for through-holes to first be introduced in the base body 31 and for the base body 31 to only then be deformed plastically at the location of these holes by means of a pressing operation in order to produce a raised edge around these holes. During the plastic deformation, these through-holes in the base body 31 will also deform, resulting in the formation of through-holes 37′ as shown in FIG. 10b for cutting body 21b′. The holes 37′ in question are then preferably round instead of square owing to the deformation that the holes 37′ are subjected to on account of the subsequent pressing operation.

FIGS. 3a to 5b relate to consecutive steps during the production of an auger ribbon part 13b. On the basis of the description, those skilled in the art will also understand how auger ribbon parts 13a and 13c can be produced. FIGS. 3a and 3b show a plate-shaped base body 61 which has been cut from sheet steel having a thickness of between 12 mm and 25 mm, for example 18 mm. In plan view, base body 61 has a spiral-shaped form, where the diameter runs from a size of d13a to a size of d13b. There is a join 62 at the location of the transition between the aforementioned diameters. The base body is also provided with a central hole 64 whose diameter is matched to that of axle body 11 so that the axle body 11 fits precisely into the hole 64 after deformation thereof according to FIGS. 5a/5b. The aforementioned holes 41 are provided along the outer peripheral edge 63 of the base plate 61.

In FIGS. 4a and 4b, it is possible to see how the base body 61 has been given a stepped form by means of plastic deformation, more specifically by bending in a press. More specifically, this stepped form is determined by a first, spiral-shaped step part 65 and a second, likewise spiral-shaped step part 67 which adjoins the inner side of said first step part via a profiled edge 66. The profiled edge 66 has an inclined profile in cross section, as shown in FIG. 4b but also in FIGS. 12a and 12b. The aforementioned holes 41 are incorporated in the first step part 65. The strip running in a spiral-shaped manner which is formed by the first step part 65 has at least substantially a constant width b. The size of width b is typically between 6 cm and 15 cm, for example 10 cm. Owing to the stepped form, there is a difference in height between the first step part 65 and the second step part 67 of size t. The size t preferably corresponds to the thickness of the wearing bodies 21, but may for example also be between 50% and 150% of the thickness of the wearing bodies 21.

In FIGS. 5a and 5b, it is possible to see how the auger ribbon part 13b is formed by further plastic deformation of the base body 61 by forcing the ends situated at the location of join 62 away from each other in a direction perpendicular to base body 61. By virtue of the aforementioned stepped form, auger ribbon part 13b has an increased stiffness with respect to the hypothetical situation where auger ribbon part 13b were not to have such a stepped form.

However, the stepped form also affords the advantageous possibility of a wearing body 21 being connectable to the auger ribbon 13, as it were, in a recessed manner, as a result of which the wearing body 21 is less susceptible to wear. In addition, the wearing body 21 will thus form less of an obstacle during the cleaning of the auger 4. This is shown in FIGS. 12a and 12b. The surface of wear blade 71 is aligned with the surface of the second step part 67 of auger ribbon part 13b. The wear blade 71 differs from wear blade 21b in that the inner peripheral edge 72 is beveled downward so that this bevel can adjoin the bevel of profiled edge 66. There is thus only a comparatively small join between this inner peripheral edge 72 and the profiled edge 66, which is favorable from the viewpoint of limiting wear but also from a hygienic viewpoint because there will then be less of a tendency for feed residue to remain there.

In a further variant of wear blade 71 as shown in FIGS. 11a and 11b, for wear blade 81, the bevel of the inner peripheral edge 82 is mirrored with respect to that of inner peripheral edge 72. The bevel of the inner peripheral edge 82 is therefore directed upward. Wear blade 81 is connected to the bottom auger ribbon part 13a which, as has already been described, does not have a stepped form unlike auger ribbon parts 13b and 13c. The inclination of the inner peripheral edge 72 ensures that feed to be mixed and cut by feed-mixing wagon 1 in the holder 3 can slide more easily from the auger ribbon part 13a over the wear blade 81 and, as a result, on the one hand, less wear of the wear blade 81 will occur and, on the other hand, the risk of feed remaining on the auger ribbon is mitigated.

1. A mixing device comprising a holder for holding material to be mixed in a mixing chamber of the holder, a mixing element which is provided in the mixing chamber, has a central axle and is rotatable in relation to the holder about an axis of rotation which coincides with the central axle for the purpose of mixing the material to be mixed in the mixing chamber during rotation of the mixing element, the mixing element comprising an axle body and a plate-shaped mixing body of at least partially screw-shaped form which extends around the axle body, is connected to the axle body and has a peripheral edge on the side facing away from the axle body, and also a plate-shaped wearing body, connecting elements each having a head and a shank, one end of said shank adjoining the head, wherein the shanks of the connecting elements respectively extend through or at least into associated mutually aligned first holes in the wearing body and second holes in the mixing body, and by means of which connecting elements the at least one wearing body is releasably connected to the mixing body, wherein the at least one wearing body at least partially extends on the outer side of the peripheral edge, characterized in that the mixing body, at the location of the second holes therein, on the side facing toward the wearing body, is provided with recesses in the middle of which the associated second holes are provided, wherein parts of the wearing body that surround the first holes extend within the recesses.

2. The mixing device as claimed in claim 1, wherein each recess has an inclined flank.

3. The mixing device as claimed in claim 1, wherein each recess is produced by machining of the mixing body.

4. The mixing device as claimed in claim 1, wherein the wearing body is produced from a plate and the parts of the wearing body that surround the first holes and that extend within the recesses are formed by plastic deformation of the plate.

5. (canceled)

6. The mixing device as claimed in claim 1, wherein a raised edge is provided at the periphery of each of the first holes in the wearing body on the side facing away from the mixing body.

7-10. (canceled)

11. The mixing device as claimed in claim 6, wherein the wearing body is produced from a plate and each first hole in the wearing body at least partially extends on the side of the thickness of the plate facing away from the associated raised edge.

12. The mixing device as claimed in claim 1, wherein the connecting elements are embodied as bolts and wherein a nut for each bolt is provided on the side of the mixing body facing away from the wearing body, wherein the nut is screwed onto the bolt and the mixing body and the wearing body are clamped against each other by the bolt head of the bolt and by the nut.

13. The mixing device as claimed in claim 1, wherein cutting teeth form at least a part of the peripheral edge of the wearing body.

14. The mixing device as claimed in claim 1, wherein at least a part of the periphery of the wearing body has a corrugated form.

15. The mixing device as claimed in claim 1, wherein at least an inner part of the peripheral edge of the wearing body is beveled in cross section.

16. The mixing device as claimed in claim 1, wherein the mixing device is provided with a number of wearing bodies which are releasably connected to the mixing body and which adjoin each other.

17-18. (canceled)

19. The mixing device as claimed in claim 1, wherein the plate-shaped mixing body has a stepped form in cross section, having a first step part and a second step part, which is connected to the first step part, on the radial outer side of the first step part, wherein the first step part and the second step part are situated at a step distance from each other in cross section and in a direction parallel to the central axle, wherein the wearing body bears against the second step part.

20. (canceled)

21. The mixing device as claimed in claim 1, wherein the axis of rotation is oriented vertically.

22. The mixing device as claimed in claim 1, wherein the mixing device is provided with a movable chassis having the holder thereon.

23. The mixing device as claimed in claim 1, wherein the at least one wearing body is provided on the top side of the mixing body.

24-28. (canceled)

29. A method for producing a wearing body for use in a mixing device as claimed in claim 1, comprising the steps of
providing a plate-shaped base body,
plastically deforming, and
making a through-hole in the recessed part.

30. The method as claimed in claim 29, wherein a circular raised edge that surrounds the recessed part is also formed during the plastic deformation, of the plate-shaped base body.

31. The method as claimed in claim 29 comprising the step of forming cutting teeth at the periphery of the plate-shaped base body.

32. (canceled)

33. A method for producing a mixing body for use in a mixing device as claimed in claim 19, comprising the consecutive steps of
providing a plate-shaped base body with a curved peripheral edge on the outer side, a central opening and a passage between the central opening and the outer periphery,
plastically deforming the base body so that the base body has a stepped form in cross section, having a first step part and a second step part, which is connected to the first step part, on the radial outer side of the first step part, wherein the first step part and the second step part are situated at a step distance from each other in cross section and in a direction perpendicular to the plane of the base body as provided,
plastically deforming the base body so that it has a spiral-shaped profile and the central axis of the spiral form extends through the central opening.

34. The method as claimed in claim 33, wherein through-holes that are close to the peripheral edge have been or will be provided in the base body before the base body is plastically deformed.

35. (canceled)
